(19) United States
(12) Patent Application Publication
(10) Pub. No.: US 2003/0043517 A1
(43) Pub. Date: Mar. 6, 2003

(54) Electro-static discharge protecting circuit

(75) Inventors: Nobuaki Tsuji, Hamamatsu-shi (JP); Terumitsu Maeno, Iwata-shi (JP)

Correspondence Address: Mr. Roger R. Wise, PILLSBURY MADISON & SUTRO LLP, Suite 1200, 725 South Figueroa Street, Los Angeles, CA, 90017, US

(73) Assignee: Yamaha Corporation, Hamamatsu-shi (JP)

(21) Appl. No.: 10/225,536

(22) Filed: Aug. 21, 2002

(30) Foreign Application Priority Data
Aug. 29, 2001 (JP) 2001-259206

(51) Int. Cl. H02H 9/00

(52) U.S. Cl. 361/56

(57) ABSTRACT

A drain of an n-channel MOS transistor NT₁ is connected to an input terminal IN for supplying an input signal to a main circuit MC, and also a source of the transistor NT₁ is connected to a reference potential Vss. A source of a p-channel MOS transistor PT₁ is connected to the input terminal IN, a current limiting resistor R₁ is connected between the drain of the transistor PT₁ and the reference potential Vss, and a source voltage Vdd=+5 [V] is supplied to the gate of the transistor PT₁. An interconnection point Q₁ between the drain of the transistor PT₁ and the resistor R₁ is connected to the gate of the transistor NT₁ directly or via a gate protecting resistor R₂.

### CROSS REFERENCE TO RELATED APPLICATION

This application is based on Japanese Patent Application 2001-259206, filed on Aug. 29, 2001, the entire contents of which are incorporated herein by reference.

### BACKGROUND OF THE INVENTION

A) Field of the Invention

This invention relates to an electrostatic discharge (ESD) protecting circuit that is suitable for metal-oxide-semiconductor (MOS) type large scale integration (LSI) device. In this specification, an expression “ESD input” means a surge voltage input due to static charge or the like.

B) Description of the Related Art

A conventional ESD protecting circuit for a MOS type LSI or the like as shown in FIG. 4 is known (e.g., refer to the prior art section in JP-A 11-68038).

In the circuit shown in FIG. 4, a drain D of an n-channel meta-oxide-semiconductor (MOS) transistor T is connected to an input terminal IN for supplying an input signal to a main circuit MC. Also, a source S, a gate G and substrate (or well) of the transistor T are connected to a ground potential (standard potential) Vss. When a positive ESD input is applied at the input terminal IN, the transistor T is turned on by the punch-through phenomenon and protects the main circuit MC from the ESD input.

In the circuit shown in FIG. 4, a breakdown voltage of a gate insulating film of the transistor T is normally about 10 [V]. A voltage higher than 10 [V] may be applied to the gate insulating film when an ESD input is applied. Therefore, there was a problem that breakdown of the gate insulating film was easy to occur.

A circuit in FIG. 5 is suggested to solve the problem (e.g., refer to JP-A 11-68038). Detailed explanation for the same parts as in FIG. 4 will be omitted by giving the same reference symbols.

In FIG. 5, a source S and a drain D of an n-channel MOS transistor T₀ are connected to a ground potential Vss and a gate G of a transistor T respectively. The transistor T₀ is turned off by supplying a source voltage Vdd, for example, at −5[V] to a gate G of the transistor T₀. By that, the gate G of the transistor T is electrically isolated from the ground potential Vss (a floating state). Therefore, the breakdown of a gate insulating film can be prevented because no voltage is applied to the gate insulating film when an ESD input is applied.

According to the circuit in FIG. 5, the breakdown of the gate insulating film of the transistor T can be prevented, however, reliability was not enough because the ESD protection could not be accomplished in case when, the transistor T failed by thermal breakdown or the like.

### SUMMARY OF THE INVENTION

It is an object of the present invention to provide an new ESD protecting circuit with improved reliability.

According to one aspect of the present invention, there is provided an electro-static discharge circuit, comprising: a terminal connected to a main circuit for inputting or outputting a signal; a first MOS transistor of a first conductivity type having a source and a drain of the first conductivity type, respectively connected to a reference potential and said terminal; a second MOS transistor of a second conductivity type opposite to said first conductive type, having a source and a drain of the second conductivity type, the source connected to said terminal, and a gate adapted to be supplied with a predetermined electrical potential for turning off the transistor when the power source is on; a first resistor for limiting electric current, connected between said second MOS transistor and said reference potential; and a connector for connecting the drain of said second MOS transistor to the gate of said first MOS transistor directly or via a second resistor for protecting the gate.

Generally, an ESD input is applied to an input/output terminal of an integrated circuit (IC) device such as LSI or the like when a source voltage is not supplied to the IC device. For example, that is when a part of a human body (a hand, a finger and etc.) touches the input/output terminal at the time of installing the IC device to a circuit substrate. In the ESD protecting circuit according to this invention, a gate voltage of the second MOS transistor is 0 [V] or the gate of the second MOS transistor is in a floating state when a source voltage is not supplied. When the gate voltage is 0 [V] and the ESD input is applied to the terminal in that state, the second MOS transistor is turned on and voltage across the first resistor increase. Increase of the gate voltage of the first MOS transistor in accordance with that voltage increase turns on the first MOS transistor. At that time, in the MOS transistor, a gate potential reaches near a drain potential; therefore, a high voltage is not applied to a gate insulating film and a breakdown of the gate insulating film can be prevented. When the gate of the second MOS transistor is in a floating state and a voltage at which source-drain path is punched through is low, a breakdown of the gate insulating film can be prevented for the same reason.

When the first and the second MOS transistors are turned on, an electrical current based on the ESD input flows dividedly through a first path via the first MOS transistor and a second path via the second MOS transistor and the first resistor. If either one of the first and the second MOS transistors fails, another transistor can accomplish the ESD protection.

As above, a series circuit of the second MOS transistor and the current limiting resistor is connected in parallel to the first MOS transistor for by-passing the ESD input. This configuration, in a state of power off, turns on the second type MOS transistor in accordance with the ESD input and turns on the first MOS transistor by increasing the gate voltage of the first MOS transistor in accordance with the voltage increase across the current limiting resistor. Therefore, this configuration can prevent the breakdown of the gate insulating film of the first MOS transistor. Also, in this configuration, either one of the first and second MOS transistors can accomplish the ESD protection. Therefore, the reliability increases.

### BRIEF DESCRIPTION OF THE DRAWINGS

FIG. 1 is a circuit diagram that shows an input protecting circuit according to an embodiment of this invention.

FIG. 2 is a cross-sectional view of a substrate, showing an example of an integrated configuration of the circuit shown in FIG. 1.

FIG. 3 is a circuit diagram, showing an input protecting circuit according to another embodiment of this invention.

FIG. 4 is a circuit diagram, showing an example of a conventional input protecting circuit.

FIG. 5 is a circuit diagram, showing another example of a conventional input protecting circuit.

### DETAILED DESCRIPTION OF THE PREFERRED EMBODIMENTS

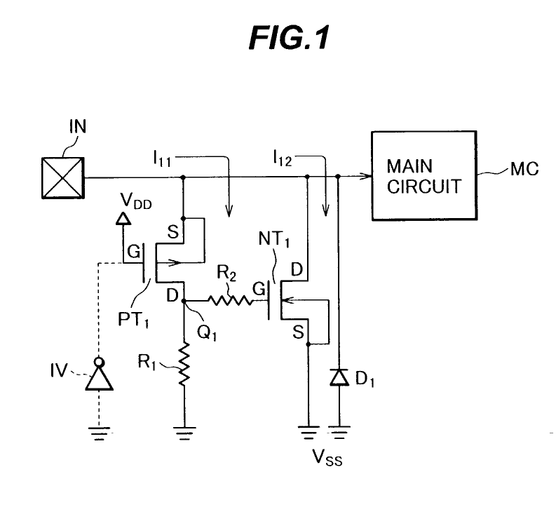

FIG. 1 shows an input protecting circuit according to an embodiment of this invention.

In the circuit of FIG. 1, a drain D of n-channel MOS transistor NT₁ is connected to an input terminal for supplying an input signal to a main circuit MC, and a source S of the transistor NT₁ and the substrate are connected to a ground potential (a standard potential) Vss. A source S and a substrate of a p-channel MOS transistor PT₁ are connected to the input terminal IN, and a current limiting resistor R₁ is connected between a drain D of the transistor PT₁ and the ground potential Vss. A resistor having a resistance ten to hundred times of ON-resistance of the transistor PT₁ (e.g., 10 to 100 kΩ) can be used as the resistance R₁.

A source voltage Vdd (e.g., +5 [V]) is supply to a gate G of the transistor PT₁ when the power source is turned on. The source volatage Vdd may be supplied from an inverter IV having an input terminal connected to the ground potential Vss. Another electrical potential different from source voltage Vdd, for turning off the transistor PT₁, may also be generated based on the supply voltage Vdd and supplied to the gate G of the transistor PT₁. An interconnection (point) Q₁ of the transistor PT₁ and the resistor R₁ is connected to a gate G of the transistor NT₁ via a gate protecting resistor R₂. The resistor R₂ may be omitted, when desired.

In the state of an normal use, 0 to +5 [V] input signal is supplied to the input terminal IN. The transistor PT₁ is always in turned-off state because an electrical potential that turns off the transistor PT₁, such as the source voltage Vdd, is supplied to the gate. The voltage at the gate G of the transistor NT₁ is therefore always 0 [V], and the transistor NT₁ is always in turned-off state. Therefore, an input signal is supplied normally to the main circuit from the input terminal IN.

When the ESD input is applied to the input terminal IN, the power source is in the turn off state as described above, and the voltage at the gate G of the transistor PT₁ is 0 [V] or the gate of the transistor PT₁ is in a floating state. Therefore, when the gate G voltage is 0 [V] and the ESD input is applied to the input terminal IN, the transistor PT₁ may be turned on by punch-through to allow an electrical current I₁₁ flow from the transistor PT₁ to the resistor R₁. The electrical potential at the point Q₁ increases with the electrical current I₁₁, and the voltage at the gate G of the transistor NT₁ will exceed the threshold voltage in accordance with the increase of the electrical potential. Thus, the transistor NT₁ is turned on, and an electrical current I₁₂ flows via the transistor NT₁. Therefore, the main circuit MC is protected from the ESD input. When the gate of the transistor PT₁ is in a floating state and a voltage at which source-drain path is punched through is low, the main circuit MC is protected from the ESD input for the same reason.

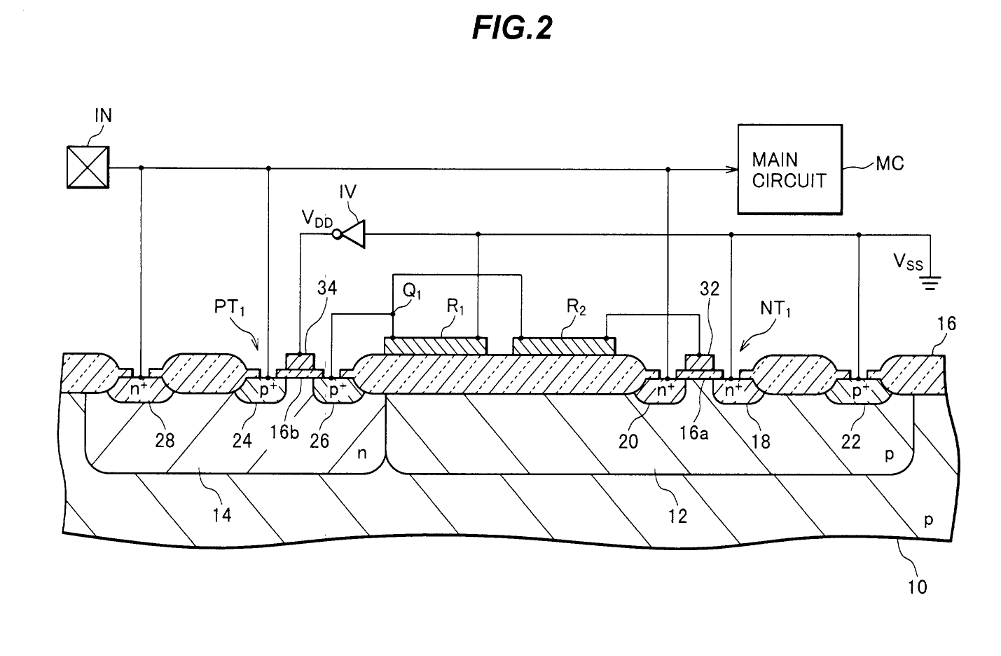

FIG. 2 shows an example of an integrated configuration of the circuit in FIG. 1. Detailed explanations for the parts similar to those of FIG. 1 will be omitted by giving the same reference symbols.

For example, a semiconductor substrate 10 made of p-type silicon has relatively low impurity concentration (e.g., lower than 10¹⁵[cm⁻³]). In one surface of the substrate 10, a p-type well region 12 and an n-type well region 14 are formed touching with each other to make a pn junction. The well region 12 and 14 have relatively low impurity concentration (e.g., 4×10¹⁶ to 1×10¹⁷ [cm⁻³]) and are formed by selective ion implantation or the like. The well regions 12 and 14 may also be formed to be isolated from each other.

The surface of the substrate 10 is covered with a field insulating film 16 made of silicon oxide or the like. The insulating film is formed by local oxidation of silicon (LOCOS). Gate insulating films 16a and 16b made of silicon oxide or the like are formed on a first and a second active regions defined by the insulating film (oxide film) 16, the active regions respectively corresponding to the well regions 12 and 14.

In the well region 12, an n⁺-type source region 18 and n⁺-type drain region 20 of the transistor NT₁ are formed, and also a p⁺-type contact region 22 is formed. In the well region 14, a p⁺-type source region 24 and p⁺-type drain region 26 are formed, and also n⁺-type contact region 28 is formed.

A gate electrode layer 32 of transistor NT₁ is formed on the gate insulating film 16a on the p-type region 12 between the source region 18 and the drain region 20. A gate electrode layer 34 of the transistor PT₁ is formed on the gate insulating film 16b on the n-type region 14 between the source region 24 and the drain region 26. Resistors R₁ and R₂ are formed on the field insulating film 16. The gate electrode layers 32, 34 and the resistors R₁ and R₂ can be formed of for example, a polycide layer (lamination of a polysilicon layer and a silicide layer).

In the transistor NT₁, the source region 18 and the contact region 22 are connected to the ground potential Vss, and the drain region 20 is connected to the input terminal IN. In the transistor PT₁, the source region 24 and the contact region 28 are connected to the input terminal IN, and the drain region 26 is connected to the ground potential Vss via the resistor R₁ and also to the gate electrode layer of the transistor NT₁ via the resistor R₂. The source voltage Vdd is supplied to the gate electrode layer 34 of the transistor PT₁ from the inverter IV when the power source is turned on.

The operation of the IC device shown in FIG. 2 is similar to the above-described device in FIG. 1. Although an negative input signal is not considered to be supplied to the input terminal IN, an negative ESD input may be applied to the input terminal IN. In this case, an electrical current flows through a path of the ground potential Vss—the contact region 22 the drain region 20—the input terminal IN (through a diode D₁ shown in FIG. 1).in accordance with the negative ESD input. Therefore, the main circuit MC is protected from the ESD input.

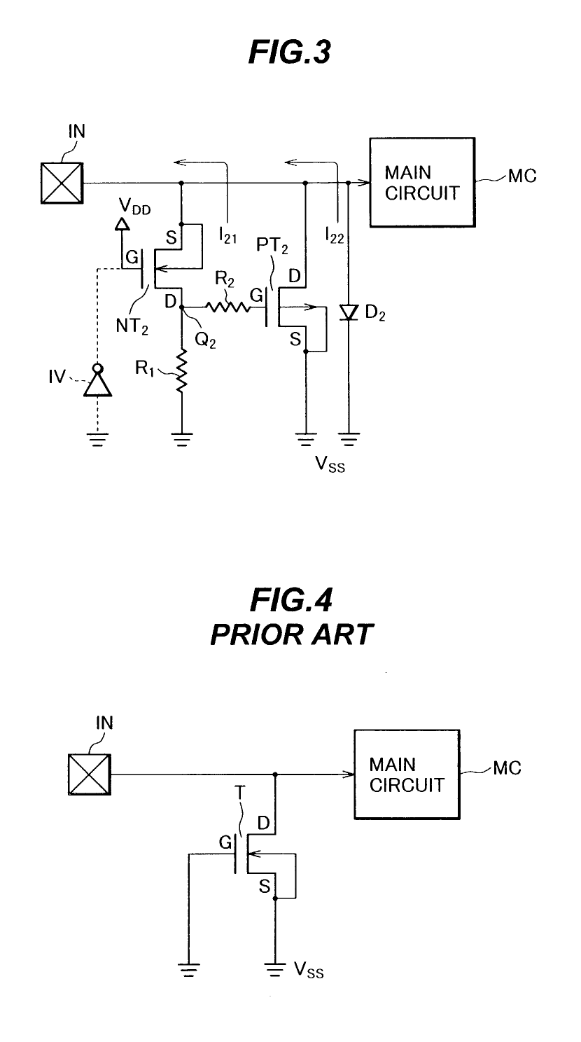

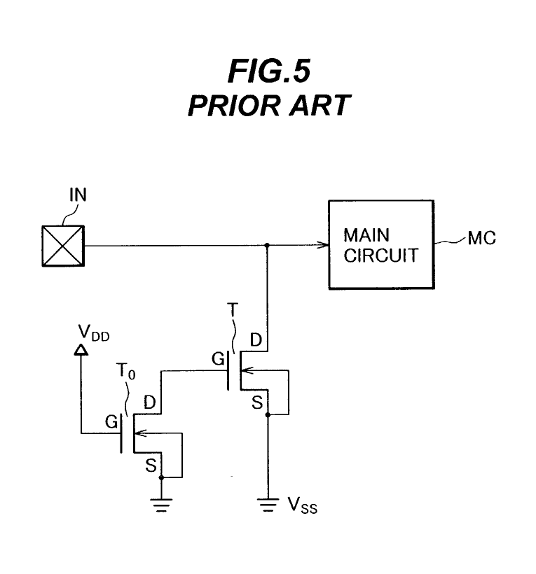

FIG. 3 shows an input protecting circuit according to another embodiment of this invention. Detailed explanations for the parts similar to those of FIG. 1 will be omitted by giving the same reference symbols.

The circuit in FIG. 3 uses a p-channel MOS transistor PT₂ instead of the transistor NT₁ and an n-channel MOS transistor NT₂ instead of the transistor PT₁ compared to the circuit in FIG. 1. In the transistor PT₂ a source S and a substrate are connected to a ground potential Vss, and a drain D is connected to an input terminal IN. In the transistor NT₂, a source S and a substrate are connected to a input terminal IN, and a current limiting resistor R₁ is connected between a drain D and the ground potential Vss.

A source voltage Vdd (e.g., +5 [V]) is supply to a gate G of the transistor NT₂ when the power source is turned on. The source voltage Vdd may also be supplied from an inverter IV. An electrical potential other than the supply voltage, that turns off the transistor NT₂ may also be generated based on the supply voltage Vdd. An interconnection Q₂ of the transistor NT₂ and the resistor R₁ is connected to a gate G of the transistor PT₂ via a gate protecting resistor R₂. The resistor R₂ may be omitted if desired.

In the state of an normal use, 0 to −5 [V] input signal is supplied to the input terminal IN. The transistor NT₂ is always in turned-off state because an electrical potential that turns off the transistor NT₂, such as source voltage Vdd is supplied to the gate. Thus, a voltage at the gate G of the transistor PT₂ is always 0 [V], and the transistor PT₂ is always in turned-off state. Therefore, an input signal is supplied normally to the main circuit from the input terminal IN.

When the ESD input is applied to the input terminal IN, the power source is in the turned-off state as described above, and the voltage at the gate G of the transistor NT₂ is 0 [V] or the gate of the transistor NT₂ is in a floating state. Therefore, when the gate G voltage is 0 [V] and the ESD input, is applied to the input terminal IN, the transistor NT₂ is turned on by punch-through, and an electrical current 121 flows via the transistor NT₂ and the resistor R₁. An electrical potential of the point Q₂ drops by the electrical current I₂₁, and the voltage at the gate G of the transistor PT₂ will become lower than the threshold voltage in accordance with the voltage drop (the absolute value of the voltage at the gate G will become higher than the absolute value of the threshold voltage). Thus, the transistor PT₂ is turned on, and an electrical current I₂₂ flows via the transistor PT₂. Therefore, the main circuit MC is protected from the ESD input. When the gate of the transistor NT₂ is in a floating state and a voltage at which source-drain path is punched through is low, the main circuit MC is protected from the ESD input for the same reason.

For example, the IC device shown in FIG. 2 can be used for the circuit shown in FIG. 3 by inverting the conductivity type of each region. In this configuration, when the positive ESD input is applied to the input terminal IN, an electrical current flows through a path of the drain region 20—the contact region 22—the ground potential Vss (through a diode D₂ shown in FIG. 3). Therefore, the main circuit MC is protected from the ESD input.

According to the above-described embodiments, in the transistor NT₁ and PT₂, the electrical potential of the gate G reaches near the electrical potential of the drain D in accordance with the ESD input, therefore, a high voltage is not applied across the gate insulating film, and the breakdown of the gate insulating film can be prevented. Also, if either one of the transistor NT₁ (or PT₂) and the transistor PT₁ (NT₂) fails, the ESD protection can be accomplished with another transistor.

The present invention has been described in connection with the preferred embodiments. The invention is not limited only to the above embodiments. It will be apparent for those skilled in the art that various modifications, improvements, combinations, and the like can be made.

What we claim is:

1. An electrostatic discharge circuit, comprising:
a terminal connected to a main circuit for inputting or outputting a signal;
a first MOS transistor of a first conductivity type having a source and a drain of the first conductivity type, respectively connected to a reference potential and said terminal;
a second MOS transistor of a second conductivity type opposite to said first conductive type, having a source and a drain of the second conductivity type, the source connected to said terminal, and a gate adapted to be supplied with a predetermined electrical potential for turning off the transistor when the power source is on;
a first resistor for limiting electric current, connected between said second MOS transistor and said reference potential; and
a connector for connecting the drain of said second MOS transistor to the gate of said first MOS transistor directly or via a second resistor for protecting the gate.
